(19) United States
(12) Patent Application Publication
(10) Pub. No.: US 2014/0274153 A1
(43) Pub. Date: Sep. 18, 2014

(54) LOCATION CONTROLLED COMMUNICATION SYSTEM

(71) Applicant: Hook Me Mobile, Inc., San Clemente, CA (US)

(72) Inventor: Michael Greco, San Clemente, CA (US)

(21) Appl. No.: 14/208,358

(22) Filed: Mar. 13, 2014

Related U.S. Application Data
(60) Provisional application No. 61/794,900, filed on Mar. 15, 2013.

(51) Int. Cl. H04W 4/02

(52) U.S. Cl. CPC H04W 4/025
USPC 455/456.3

(57) ABSTRACT

A location-controlled communication system for individualized communication between each of a plurality of customer PDA associated with a specific location at an event venue and selected Internet websites. Each physical location in the venue includes at least one location-identifier device. The customer PDA receives location information from the location-identifier device. Information on the PDA including its location is communicated to an EIS server. The EIS server can send particularized data to the PDA that may be based on the location, event, venue or other data and may send other data from the Internet.

### BACKGROUND

1. Field

A location-based two-way communication system where a customer with a mobile device can communicate with resources on the Internet at a venue during an event and do so anonymously. More particularly, it is a communication system between a customer PDA and the Internet that includes an experience intelligence system server, which processes information based on the location of the customer and provides a proxy customer identity for the customer to protect the customer's identity from the Internet destination.

2. Related Application

This application claims priority to U.S. Provisional Application No. 61/794,900, filed Mar. 15, 2013, and naming Michael Greco as inventor. Applicant incorporates the entire contents of the provisional application by reference.

3. General Background and State of the Art

Location-based marketing systems are known. However, such systems generally provide for communication of advertising to the customer who generally is in close proximity to the advertiser so that the customer can respond immediately to the offer. Such a system only needs to rely on imprecise location information such as that provided through a GPS system on a cell phone.

Communications through a customer mobile device and the Internet are also well known. Such systems permit two-way communications. In such systems, a customer may log into the Internet and order a product or service. The company fulfilling the order delivers the product or service a later time to location identified by the customer when the customer places the order. For example, a customer can log into the Amazon.com website, select and order a book, provide the location address where the book is to be delivered and provided payment information to the website. The customer will receive the book one or more days later. While such systems are useful for ordering products that are delivered to an address provided by the customer through the mobile device, such systems still require the customer to provide the shipping address location (or use a stored address) and then wait for the product be delivered.

While such systems are useful for the above-described application, they are inadequate for targeted advertising or the ordering and delivery of goods or services to the seat of a ticket-holder during an event because the ordering and deliver must take place within minutes, not days. The advertiser would like to send a solicitation to the customer that is targeted to the location of the customer seat and the products or services at or related to the venue or event that the customer is attending. The solicitations also are time sensitive, being targeted only during a window of time while people are attending the event.

For example, where the customer is at an event such as a baseball game, concert or other event at a particular venue, it would be advantageous for the customer to be able to order goods or services from his seat using a smartphone or other mobile communication device (PDA) or otherwise interact directly with the venue and concessions in real time and have the goods or services delivered or provided at the seat where the customer is located. Such a system would allow a customer to order food from the customer's seat without missing the action, have the food delivered at the customer's option, engage in games or promotions offered by the venue through the public display, provide additional details regarding the event or participants, offer upgrade to seats, and the like, all in real time.

For such a system to work, the specific location of the customer seat would have to be read by the customer PDA and then communicated to the venue or concessionaire. While it may be possible for goods and services to be ordered directly by contacting the website of the venue or concessionaire, the difficulties encountered with electronic traffic at an event attended by thousands of people all trying to use the same system could prevent the direct approach from working. Furthermore, the customer would have to give his identity and the web address of his PDA. The customer may be deterred from using such a system if such information must be provided. The time to provide such information each time an order is placed would prevent maximizing the benefit of such a system and would limit the quantity of sales possible.

Therefore, it is also desired to have a system where it is not necessary for the customer to provide his personal information each time an order is given and where the customer PDA address can be kept confidential.

Consequently, there is a need for a system which can provide real time communication between customers and the venue/concessionaires to enable commercial transaction to take place while minimizing the time between ordering and delivery and further to allow the identity of the PDA user to be based on the customer's seat location, not the identity of the PDA address or the identity of the customer. In such a system, the PDA user will be able to order products, services, food, beverages and souvenirs through the website of the venue and venue concessions and otherwise interact with the venue by reading the seat location from a unique seat specific QR code or other similar passive or active device, storing the seat location in the customer PDA and using that location and the customer identifier rather than using the actual identity of the customer PDA IP address to complete such transactions.

### SUMMARY

The system and method enables real-time interaction between multiple customers at their ticketed seats before, during and after an event at that venue through an experience intelligence system (EIS) which includes one or more servers (hereafter, “server”). The EIS server processes information from a customer received from a customer PDA where the information includes the seat location of the customer. The location information is provided from an event ticket or a custom label affixed on or in close proximity to, for example, a seat that includes a quick response code (QR code), near field communication chip (NFC chip), or any other device capable of communicating the location of the customer seat. This information is provided to the EIS server from the customer PDA. The EIS server processes the information from the customer PDA and passes that information on to one or more selected Internet websites. The EIS server assigns a proxy customer identifier to the information sent to third party websites to protect the privacy of the customer identity and the identity of the customer PDA from third party server(s) and to enable real time information and interaction options based on the customer location received by the customer PDA (e.g., a QR code) and the time of the scan which can be correlated with currently occurring events, and any other user information to enhance the user's experience.

After the customer PDA acquires the seat location information, a communication link can be initiated between the customer PDA and the EIS server. The EIS server then can communicate information to the customer PDA as to events, products, games, discounts, merchandise specials, options, etc. to let the customer know the availability of those events, products, games, discounts merchandise specials, options, etc. available to the customer based, at least in part, on the customer seat location, derived scanning that information from the ticket or QR code label or receiving the transmission of the information from the NFC chip for the seat, ticket, NFC chip, customer label or other location-identifier device is intended to encompass any similar device capable of communicating the identity of the physical location of, e.g., the customer seat. Because QR codes are common, the application refers to the ticket, QR code, NFC chip or other identifies as “OR code.”

The QR code associated with the seat may include not only the location information but the URL of the EIS server as well as any other desired information such as the venue, event, date, and the like. As such, the location is not determined by the GPS, which generally cannot identify the location of a seat with sufficient precision to define a unique location for each seat. Thus, the QR code with location information protects customer privacy information but still gives providers location information for delivery of unique seat specific offers e.g., food orders at events. By knowing the unique location of the seat using the QR code, the customer can interact with venue websites to order products, food, etc. which can be paid for through the PDA and delivered to the customer seat at the election of the customer.

The user also can interact through the EIS server with third party websites to learn what items might be available to the customer based on the time of day or night of the scan, the event where the scan took place (e.g., a sporting event, play, etc.) and the location of the QR code scanned by the customer PDA.

The customer's experience with the EIS system is not intrusive unless authorized by the customer. For example, the first time the EIS server communicates with the customer PDA, the EIS server only knows the location of the customer based on the location information from the scanned QR code. Therefore, the customer does not need to provide any information to the EIS server to communicate and obtain services and products since the user is identified exclusively by the seat location of the customer. Therefore, the customer's private information is not needed to enable effective interaction. Also when the customer does provide authorization the EIS server to accumulate and store the customer's experience information, that information is retained in the EIS server and is not shared with third party server(s) unless the customer explicitly requests such information to be shared.

When a customer does allow for the gathering and storage of customer experience information, the EIS server begins to accumulate the customer's interaction (experience) history, in conjunction with other relevant information related to actions occurring during the time that the customer is interacting with EIS server.

Simultaneously while the EIS server is interacting with the customer's PDA, it is receiving information or otherwise determining what offers, products, services or entertainment are available to the customer based on the customer's preferences, history, location and time of log on. Using this information, the EIS server, acting as a “information manager” interacts with the customer to offer products, services, food, drinks, entertainment and any other information option that are available from third parties through the EIS server or even from the EIS server itself where the offerings are selected and presented to the customer based on such criteria as the location of the customer PDA, the time of the scan and any available user preferences. Therefore, instead of exposing the customer to products and services from any source on the Internet, the EIS server acts as an intelligent “filter” that provides only what a particular customer or user at a particular time and in particular location has requested or the EIS server has determined is likely to want, considering any customer preferences, to selectively prevent communication of such information. Accordingly, the system is intended to provide the customer with a personalized, real-time experience based on real-time and historical intelligence.

According to one embodiment, the EIS server processes and analyzes offers and requests and can present, change and manage different offers, messages or experiences uniquely for each user individually or in groups at a venue event. The EIS server also can capture and synthesize customer and venue experiences and provide the venue or other sponsor with actionable data that can be used to tailor messaging provided through the EIS server to the customer while at events at the venue.

The EIS system also provides interactivity and communication between the customers and venue at an event. It also can provide tour bus or public transportation riders with offers that are time and location sensitive by including a custom label with a QR code for each seat so the location of the seat where the rider is seated will be known and the geographic location can be determined from readings provided by the customer PDA, the bus schedule or by the bus itself using an on-board GPS or fleet management systems.

### BRIEF DESCRIPTION OF THE DRAWINGS

FIG. 1 is a block diagram illustrating an arrangement and functioning of the location based system.

FIG. 1A is a block diagram showing a detail of the customer PDA that uses the system.

### DETAILED DESCRIPTION

Referring to FIG. 1, a location-based communication system 10 in a venue 40 includes a plurality of location-identification devices 42, each installed at a different, specific, physical location 44 throughout the venue 40. For example, the specific physical locations may be individual customer seats at the venue. The location-identification devices 42 may be a QR code label identifying a specific the location of an individual seat either affixed near the seat location or printed on the customer ticket or both. It also may be a near-field communication (NFC) device programmed with the specific location. It also could be another device capable of storing location information that may be sent to or read by a customer PDA 20. The location-identification devices may communicate the location information to a customer's PDA 20 when that PDA is in sufficiently close proximity

While the location-identification device, whether on a ticket for a seat or affixed near the seat and regardless of whether passive or active, at least must include information identifying a physical location of the seat or related to the seat that can be communicated to or read by the PDA 20 of the customer who purchased or was assigned that seat for the venue event.

By way of illustration, reference will be made to just one location-identification device 42 associated with a specific physical location 44. However, a venue would have many location-identification devices 42a , each at a unique physical location 44b .

The particular venue 40 may be any place where people congregate. For example, the venue may be a sports stadium such as a baseball stadium, a concert hall, a hotel, a conference center, or a movable venue such as a bus. In the event the venue is movable such as a vehicle, the EIS server may be adapted to receive communication from the vehicle as to the vehicle's GPS position. For example, a moveable venue such as a bus would include venue-location device 45 such as a GPS device that could provide GPS information to the customer PDA, or the customer PDA could have a GPS device which would provide the position GPS position of the bus along with the location-identification information from the location-identification device at the seat on the bus. The GPS venue location device then would provide the less precise GPS location information while the location-identification devices would provide the information about the specific seat location on the bus. Both the GPS information for the bus and the location-identifier information from the location-identification device 42 for the seat-on-the-bus 40 then will be received and processed by the customer PDA 20 into the customer information set which is communicated as the customer information set along a PDA/server communication link 50.

The communication link 46 over which the location-identifier information is communicated may be an optical link, an electronic link or any other type of communications link that will enable location-identifier information to be communicated to the customer PDA. For example, the location-identification device 42 may be a unique QR code applied to a physical location in proximity to the associated seat, which can be read by a QR code reader available as an app on the customer PDA 20. In that case information is transmitted from the QR code to the customer PDA optically. Alternatively, if the location information is stored in an NFC chip positioned in close proximity to the seat the location information is communicated to the customer PDA 20 when that device comes into sufficiently close proximity to the NFC chip.

It will be understood that in any venue there will be multiple location-identification devices each having a communication link 46 for transmitting location-identification information 47 for the specific physical location associated with the device to a customer PDA 20. Thus, each such location-identification device will be associated with a different seat and each seat will be assigned to a different customer with a different customer PDA.

In describing the system hereafter, reference will be made for illustration purposes only to a single location-identification device and a single customer PDA 20. It will be understood that though the QR code or the NFC device essentially will store and communicated the location information for the seat with which it is associated, other information also can be included in the QR code device of NFC device. Such information could include the identification of the venue, event, a venue seat section, the network web address of the EIS server 60, or any other information that might be useful in communications between the customer PDA 20 and the EIS server 60. This information is communicated to the customer PDA 20. In the customer PDA 20, the customer 30 may insert additional information such as orders for food our souvenirs, from venue concessions; respond to offers such as premiums, offers of future event tickets, offers of seat upgrades; and any other commercial interaction with the customer PDA 20. In addition, experience intelligence information stored in the customer PDA from past interactions with the Internet whether though the EIS server 60 or directly with the Internet 70, could also be selected by the customer 30. Alternatively information generated by automatic selection processes of the customer PDA 20 could be included in the information to be communicated to the EIS server. The result is a customer information set that is communicated through the PDA/server communication link 50 from the customer PDA 20 to the EIS server 60.

The customer information set to be communicated over a PDA/server communication link 50, the EIS server 60 can be a WiFi, hotspot, hard-wired, Bluetooth or any other type of communications link between the customer PDA 20 and the EIS server 60.

To enable communication between the customer PDA 20 and the EIS server 60, the customer PDA 20 will be characterized by a PDA address which, for example, may be in a network IP address or other type of address that will be communicated to the EIS server 60 as part of the customer information set communicated along the PDA's/server communication link 50. Also included in the customer information set is the network web address 62 of the EIS server 60 according to well-known Internet communication protocols.

The communication link between the customer PDA 20 and the EIS server 60 is initiated when the first customer information set is sent from the customer PDA to the EIS server. Thereafter, customer information sets will be formed periodically and communicated from the customer PDA 20 to the EIS server 60 in response to customer initiated requests for information or, for example, responses to venue offers or solicitations. Though the customer still may link directly to the Internet through the customer PDA using the EIS server, the customer 30 is enabled to communicate anonymously with the Internet 70 by providing the customer information set to the EIS server 60.

Considering the operation of the EIS server 60, when the customer elects to send a customer information set to the EIS server 60 over the PDA/server communication link 50, that customer information set is processed in several ways by the EIS server 60. For example, initially the customer information set is processed by login processors 65 which may perform such functions as locating previously gathered and stored customer intelligence information for that customer 30 or the customer PDA 20 based on prior interactions with the customer PDA 20 at other events and venues. The EIS server also includes a proxy customer processor 64 that receives the PDA address for the customer PDA 20 and converts that address into a proxy customer identifier. The identifier is used in communications from the EIS server 60 to the Internet 70 on behalf of the customer PDA 20. In this way, the actual PDA address of the customer PDA is kept from the Internet 70 in communications between the customer 30 and the Internet 70 through the EIS server. Over the course of interactions between the customer and the EIS server during an event at the venue, the customer intelligence memory continues to select and save information about the preferences and interests of the customer 30. Of course the customer 30 is always able to identify him or herself to the Internet by providing appropriate contact information in response to a request from the Internet 70. However, the customer will be control whether to communicate such identifying information to Internet 70. Consequently, the customer 30 is able to maintain the anonymity of the PDA address of the customer PDA 20 so that any communication from the Internet 70 will flow through the EIS server and be processed by the EIS server according to programmed protocols before being passed on to the customer PDA 20.

Also included in the EIS server 60 is a protocol processor 63, which accepts the customer information set with the PDA address replaced by the proxy customer identifier, combines that information with any customer intelligence information from the customer intelligence memory and processes that information according to first protocol defined by criteria for selecting, sorting, modifying the resultant data to define a customer Internet request which is communicated to the Internet 70 through a server/Internet communication link 74. The customer Internet request will include the proxy customer identifier as well as any other information that has been selected, modified or added to information in the customer information set from the customer PDA 20.

The Internet 70 can include any of a plurality of websites such as illustrated websites 80, 82, 84, and 86 or any other website available on the Internet. However, the EIS server 60 may be programmed to allow only a selected subset of preapproved websites that are allowed to receive communications from the customer PDA 20 through the EIS server 60 or to received and pass communication from the Internet back to the customer PDA 20. For example, various advertising servers 80, product servers 82, gaming servers 86 and venue concession websites 84 may be selected by the EIS server 60 to provide information or services requested by to the customer PDA 20. Such servers preferably can be selected based upon venue preferences and customer intelligence information from the EIS server 60.

Once the customer Internet request has been generated by the EIS server according to the first processing protocol, it is sent to the Internet 70. The websites accessed to respond to the customer Internet request create response information that includes the information requested by the customer PDA 20 and the proxy customer identifier and communicates that response through an Internet/server communications link 76 to the EIS server 60 (using the network web address 62 for the EIS server). The EIS server then processes that response information according to a second protocol, which modifies, adds to, or deletes information and changes the proxy customer identifier back to the PDA address for the customer PDA 20. In addition, the response information also may be used to add to, modify or process information that may be used to update the customer intelligence information stored in the customer intelligence processor 66.

The information resulting from processing according to the second protocol then is communicated to the customer PDA 20 along a server/PDA communications link 36. The second protocol may include any desired processing to provide the customer PDA with information customized for that customer according to the customer's profile in the customer intelligence memory and the customer's request for information from the Internet 70.

The venue/concession website 84 also is an advantage because it enables the venue to interact with the customer during an event at the venue. For example, the venue/concession website 84 offers products such as memorabilia or souvenirs directly through the EIS server to the customer PDA 20 or invitations displayed on large video screens at the venue. The EIS server may offer food and beverages from concessions at the venue. It also could provide services such as reserving seats at future events. The venue could deliver food, beverages, souvenirs, tickets or other items ordered by the customer 30 through the customer PDA 20. The EIS server also could offer upgraded seats, especially to customers in less-desirable seats.

For example, a customer 30 may order a hot dog and elect to have the hot dog delivered to the customer physical location 44. The customer 30 can request such service through customer PDA 20 once a connection to the venue/concession website is made through the EIS server 60. This communication link can be continuous. Thus, the venue can send an electronic order form to the customer PDA 20 periodically to which the customer responds with an order for products or service and pays for such service or products by entering the appropriate payment information, which is communicated through the EIS server 60 to the venue/concession website 84 in the Internet 70. Because the location-identification information is sent along with the order, the venue/concession knows where to deliver the ordered goods and services if the customer 30 has requested delivery services.

Other options may be desired by the customer 30 as well. For example, an invitation through the venue large video display or other communication means may be made for the customer to engage in playing a game on a game server 86. In this example, the customer 30 inputs customer information through a customer input link 32 that the customer accepts the invitation to play the game. That information then will be included in the customer information set sent by the customer PDA 20 to the EIS server 60 where the proxy customer identifier replaces the PDA address of the customer and is then linked to the game server 86 where the customer 30 engages in playing the game with all communications occurring between the customer PDA 20 and the game server 86 through the EIS server 60. Such a system would direct all communications back to the EIS server.

In another example, an Internet website may desire to interact with some or all of the customers at a venue event such as providing an offer of products or services, offers of tickets for future events or other information or invitations to engage in commercial transactions. In such an example, the Internet website would initiate the communication with selected customers at specified physical locations in the venue. While the physical locations would be known and based on that knowledge, the communication could be directed to those locations without the need to know anything about the customer, the customer PDA or even whether a customer PDA had established a link with the EIS server. Instead, the communication would be sent to the EIS server with a request for the EIS server to deliver the message or information to all of the locations identified. The EIS server, using a third processing protocol, would receive the requests, identify all locations in the requested set of locations for which communication had been requested and then determine which of those locations had a linked, customer PDA. The EIS server then would communicate that message or information from the Internet 70 to all such selected customer PDAs along the server/PDA communication link 36. Of course, the third protocol also could include other selection or deselection criteria such as an instruction from the customer PDA not to forward any unsolicited communication from the Internet.

In accordance with an embodiment, the customer PDA 20 can initiate and thereafter communicate with the EIS server during an EIS server defined communication time window. For example, the communication time window can be defined by the EIS server in response to instructions from a venue operator (or other entity) as being the time period encompassing an event at the venue during which communications between the customer PDA and third party websites takes place through the EIS server. This period may include the period several hours before an event starts, the period during the event or for a period of minutes to several hours after the event ends. The connection to the EIS server during the communication time window commences with the reading of the location-identifier information device, which also provides the user authorization to communicate with the EIS server.

In operation, the customer 30 initiates an interaction session between the customer PDA and the EIS server by communicating the customer information (including the PDA address) from the customer PDA to the EIS server. That session continues until terminated such as by affirmative disconnecting by the customer PDA, by expiration of a predefined programmed time period, or by the EIS server such as when the communication time window ends or is otherwise closed. Other events also can terminate a session such as when a customer upgrades to another seat and provides new location-identifier information, changing venues, leaving the venue, or any other event that occurs that will terminated the interaction session. Once the interaction session is terminated, the EIS server terminates communication links between the customer PDA and any venue/concession server 84, advertising server 80, product server 82 or gaming server 86 through the EIS server as will be describer hereafter.

At the beginning of an interaction session between a customer PDA and the EIS server, the EIS server receives the customer information set from the customer PDA and processed that information according to the protocols programmed in the EIS server so as to keep the PDA address and customer PDA identity confidential between the EIS server and the customer PDA. The EIS server processing would use the customer information set which includes the PDA address, information in the EIS server data base such as the customer PDA historical preferences, information regarding the customer PDA's past interactions through the EIS server, third party or venue preferences, actions or criteria or any other protocol by which the customer Internet request is generated.

As indicated above, the EIS server communicates with various Internet sites such as venue/concession sites 84, advertising websites 80, product vendor sites 82 or game sites 86 selected in response to requests by the customer 30 from the customer PDA and the EIS server's customer intelligence memory in response to criteria defined by the customer through the customer PDA. To implement this functionality, the EIS server may include a website list or application programming interface (API) which correlates products, services, advertising or venue communications according to the EIS server processing protocols. The connection between the EIS server and these sites may be initiated by the EIS server or by advertisers, venues, product or service providers seeking to interact with the customer PDA. The EIS server evaluates all such attempts acting as a filter to permit information communication with venues, advertisers, product suppliers and service suppliers that may meet predefined criteria according to the EIS server programmed protocols. Then such communications will be processed by the EIS server where communications (either from or to the customer PDA, third-party websites or the EIS server database) can be modified, truncated, edited or censored according to the protocols programmed in the EIS server.

Acting as a filter, the EIS server can prevent, deny, approve, enable, modify or reformulate any communications between the PDA users, venues, vendors, advertisers, product sellers or service providers. It process the content of such communications according to customer wishes or EIS programmed protocols.

The description is illustrative and not limiting and is by way of example only. Although this application shows and describes examples, those having ordinary skill in the art will find it apparent that changes, modifications or alterations may be made. Many of the examples involve specific combinations of method acts or system elements, but those acts and those elements may be combined in other ways to accomplish the same objectives. With regard to flowcharts, additional and fewer steps may be taken, and the steps as shown may be combined or further refined to achieve the methods described. Acts, elements and features discussed only in connection with one embodiment are not intended to be excluded from a similar role in other embodiments.

“Plurality” means two or more. A “set” of items may include one or more of such items. The terms “comprising,” “including,” “carrying,” “having,” “containing,” “involving,” and the like in the written description or the claims are open-ended, i.e., each means, “including but not limited to.” Only the transitional phrases “consisting of” and “consisting essentially of” are closed or semi-closed transitional phrases with respect to claims. The ordinal terms such as “first,” “second,” “third,” etc., in the claims to modify a claim element do not by themselves connote any priority, precedence, or order of one claim element over another or the temporal order in which acts of a method are performed. Instead, they are used merely as labels to distinguish one claim element having a certain name from another element having a same name (but for use of the ordinal term). Alternatives such as “or” include any combination of the listed items.

What is claimed is:

1. A location based communication system for individualized communication with one or more from a plurality of a customer PDAs each having a different PDA address, each customer PDA selectively associated with a specific physical location in a venue during the period of an event at the venue, the customer PDA having a transceiver for communicating customer request information to selected Internet websites in the Internet, the system comprising:
at least one location-identifier device associated with each of the plurality of physical locations in the venue, location-identifier information being associated with each location-identifier device, and a web address, being selectively communicated to the customer PDA from the location-identifier device;
an EIS server accessible by the web address, the EIS server positioned in a communication path between each customer PDA in communication relationship with the EIS server, and the Internet, to receive communication of a customer information set from the customer PDA, the customer information set including at least the PDA address, the web address, the location-identifier information and any customer request information from the customer PDA, the EIS server processing the customer information set according to a first protocol to define a proxy customer identifier for each customer PDA and a customer Internet request, communicating the proxy customer identifier and the customer Internet request to the Internet, receiving response information from the Internet, processing the response information according to a second predefined protocol, and replacing the proxy customer identifier with the PDA address for communicating the processed response information to the customer PDA.

2. The location based communication system of claim 1 wherein the customer information set further includes PDA supplied information.

3. A method for anonymous communication with Internet resources from a physical location associated with a customer PDA having a PDA address comprising the steps of:
associating at least one location-identifier device with each specific physical location at an event venue, where the location-identifier device is characterized by location-identifier information for the specific physical location;
associating the customer PDA with the specific physical location by enabling communication of the location-identifier information to the customer PDA;
communicating a network web address of an EIS server to the customer PDA;
initiating a communication session between the customer PDA and the EIS server when the EIS server receives from the customer PDA a customer information set which includes the location-identifier information, the network web address of the EIS server, the PDA address of the customer PDA and customer request information from the customer PDA;
processing the customer information set and customer intelligence information stored in the EIS server according to a first protocol, the first protocol substituting a proxy customer PDA identifier for the PDA address, processing the customer information set and the stored customer intelligence information to define a customer Internet request;
communicating the customer Internet request and the proxy customer PDA identifier to one or more websites in the Internet;
receiving response information to the customer Internet request from the one or more websites, the response information including customer response information and the proxy customer PDA identifier;
processing the response information in the EIS server according to a second protocol which substitutes the PDA address for the proxy customer PDA address and modifies the customer response information to define an Internet response information set (36b); and
communicating the Internet response information set generated by the EIS server to the customer PDA having the PDA address.

4. The method of claim 3 further comprising the step of modifying the customer intelligence information stored in the EIS server in response to processing according to the first protocol.

5. The method of claim 3 further comprising the step of modifying the customer intelligence information stored in the EIS server in response to processing according to the second protocol.

6. The method of claim 2 comprising the further steps by the EIS server of receiving an Internet initiated request initiated from one or more of the websites;
processing the Internet initiated request according to a third processing protocol to define processed request information; and
using the processed request information to modify the customer intelligence information in the EIS server.

7. The method of claim further comprising the further steps by the EIS server of receiving an Internet initiated request by the EIS server;
processing the Internet initiated request by the EIS server according to a third processing protocol to define processed request information; and
communicating the processed request information to one or more selected customer PDAs.

8. The method of claim 7 wherein the Internet initiated request includes an advertisement to be directed to the selected customer PDAs.

9. The method of claim 8 wherein the Internet initiated request further includes an identifier code associated with each advertisement.

10. The method of claim 3 wherein the venue is a moveable vehicle with a vehicle position location device for communicating location information of the vehicle, the EIS server further performing the steps of:
receiving the location information communicated by the vehicle position location device,
selecting a message to be sent to one or more customer PDA according to the location information received, and
communicating the message to a selected set of the customer PDAs at the venue vehicle.

11. The method of claim 3 further comprising the steps of:
receiving an Internet initiated request by the EIS server to communicate information from the Internet to a set of customer PDAs in communication relationship with the EIS server;
processing the Internet initiated request by the EIS server according to a third processing protocol to define a processed request information set; and
communicating the processed request information set to the set of customer PDAs.

12. The method of claim 9 wherein the set of customer PDAs is selected based on one or more of the following: the physical location with which a location-identifier device is associated; an event at the venue; a defined time period; and a technical feature of the customer PDA.
